(19) United States
(12) Patent Application Publication
(10) Pub. No.: US 2024/0202923 A1
(43) Pub. Date: Jun. 20, 2024

(54) CO-DESIGN OF OPTICAL FILTER AND FLUORESCENCE APPLICATIONS USING ARTIFICIAL INTELLIGENCE

(71) Applicant: CARL ZEISS MEDITEC AG, Jena (DE)

(72) Inventors: Stefan SAUR, Oberkochen (DE); Mirco WILTBACH, Oberkochen (DE); Alexander FREYTAG, Oberkochen (DE); Anna ALPEROVICH, Oberkochen (DE)

(21) Appl. No.: 18/571,021

(22) PCT Filed: Jun. 15, 2022
(86) PCT No.: PCT/EP2022/066313

§ 371 Date: Dec. 15, 2023

(30) Foreign Application Priority Data
Jun. 16, 2021 (DE) 10 2021 115 587.8

(51) Int. Cl. G06T 7/00

(52) U.S. Cl. CPC G06T 7/0012; G06T 2207/10024; G06T 2207/10064; G06T 2207/20081; G06T 2207/20084

(57) ABSTRACT

A computer-implemented method for predicting digital fluorescence images is presented. The method comprises capturing a first digital image of a tissue sample by means of a microsurgical optical system with a first digital image capturing unit with a first plurality of color channel information using white light and at least one optical filter, as well as, predicting a second digital image in the form of a digital fluorescence representation of the captured first digital image by means of a trained machine learning system comprising a trained learning model for predicting a corresponding digital fluorescence representation of an input image. Thereby, the first captured digital image is use as input image for the trained machine learning system, and parameter values of the at least one optical filter have been determined during training of the machine learning system.

### CROSS-REFERENCE TO RELATED APPLICATIONS

The present application is the U.S. National Stage entry of International Application No. PCT/EP2022/066313, filed Jun. 15, 2022, which claims priority under 35 U.S.C. § 119 to German Patent Application No. 10 2021 115 587.8, filed Jun. 16, 2021, the contents of which are incorporated by reference herein in their entirety.

### FIELD OF THE INVENTION

The invention relates to a prediction method by means of a machine learning model, and in particular to a computer-implemented method for predicting digital fluorescence images. The invention further relates to a prediction system for predicting digital fluorescence images and to a computer program product.

### TECHNICAL BACKGROUND

Brain tumors involve a not infrequently occurring type of cancer that is comparatively aggressive and often has relatively low treatment success with a survival chance of approximately ⅓. Treatment of such diseases typically requires a surgical intervention for removal, radiotherapy and/or subsequent, usually lengthy, chemotherapy. A biopsy has often formed the decision basis for the respective treatment, with molecular tests being used as well. Of course, such interventions entail medical risks. The possibilities for analyzing radiometrically recorded images have recently become very advanced and, as a result of this, such tumor examinations can at least complement biopsies. This may be the case if biopsies are not possible or are undesirable. Recently these image-based diagnoses have even been able to be used during an operation. However, the required computing power is currently extremely high, which is why actual real-time support has not been possible hitherto.

It is not only in the field of brain tumors that diseased tissue regions have to be removed completely and as precisely as possible in order to prevent diseased tissue—i.e. tumor-containing tissue—from growing into healthy tissue again, and in order to retain as much healthy tissue as possible. This partial removal of tissue (resection) is normally carried out by a surgeon in an operating theater equipped with special instruments. A surgical microscope is also generally used for this purpose. In this case, the exact boundary line between healthy and cancerous tissue is recognizable only with difficulty under the typical white operation light. As a result, there is clearly the risk of too much healthy tissue or too little cancerous tissue having been removed after the resection. Both results may be designated as suboptimal.

Hitherto it has generally been necessary, moreover, to inject a contrast agent in order to differentiate relatively clearly between healthy and diseased tissue under optimized lighting (e.g. BLUE400 or YELLOW560). As a result, it also becomes necessary to have to switch between lighting presettings relatively frequently during the operation, which as a rule leads to longer operation times, overall higher operation costs and to less patient-friendliness.

The prior art does indeed disclose initial approaches for using artificial intelligence to ascertain a fluorescence image from a tissue recording that was recorded under white light. Nevertheless, high-resolution cameras having a multiplicity of color channels are required for this purpose.

It would thus be desirable to have minimally invasive operation support that helps the surgeon, in real time—i.e. without a significant time delay—and without great distraction of attention, to differentiate unambiguously between healthy and cancerous tissue in order that the patients are thus subjected only to minor additional treatments (e.g. chemotherapy).

### OVERVIEW OF THE INVENTION

This object is achieved by means of the method proposed here, the corresponding system and the associated computer program product in accordance with the independent claims. Further configurations are described by the respectively dependent claims.

In accordance with one aspect of the present invention, a computer-implemented method for predicting digital fluorescence images is presented. In this case, the method can comprise capturing a first digital image of a tissue sample by means of a microsurgical optical system with a first digital image capturing unit with a first plurality of color channel information—or number of color channels—using white light and at least one optical filter. Furthermore, the method can comprise predicting a second digital image in the form of a digital fluorescence representation of the captured first digital image by means of a trained machine learning system comprising a trained learning model for predicting a corresponding digital fluorescence representation of an input image. In this case, the first captured digital image can be used as input image for the trained machine learning system, and parameter values of the at least one optical filter can have been determined during training of the machine learning system.

In accordance with another aspect of the present invention, a prediction system for predicting digital fluorescence images is presented. The prediction system can comprise a microsurgical optical system with a first digital image capturing unit with a first plurality of color channel information—or number of color channels—and an optical filter for capturing a first digital image of a tissue sample using white light and at least one trained machine learning system. In this case, the machine learning system can comprise a trained learning model for predicting a corresponding digital fluorescence representation of an input image. It can be adapted for predicting a second digital image in the form of a digital fluorescence representation of the captured first digital image. In this case, the first captured digital image can serve as input image for the trained machine learning system, and parameter values of the at least one optical filter can have been determined during training of the machine learning system.

The proposed computer-implemented method for predicting digital fluorescence images has a plurality of advantages and technical effects which may also apply accordingly to the associated system:

The practice according to which underlying computer systems of varying performance levels are used for creating the machine learning model in the training phase and using the machine learning model in the prediction phase is developed further by the method proposed here. In principle, the available time for the development of the machine learning model is longer in the training phase than during the prediction phase. In the prediction phase—i.e. during productive use—an output of the machine learning system should be possible with the shortest possible time delay. This is essential primarily when the machine learning system is used in real-time situations—such as for supporting surgical interventions, for example.

According to the concept proposed here, a hyperspectral camera can be expediently used for creating the training data, this camera making available a large plurality of different color channel information. From this starting point, during the training process in an integrated approach the number of color channels is then significantly reduced by a digitally simulated optical filter in order to anticipate the available resources during the prediction phase as early as during the training phase. For this purpose, both the machine learning system with its integrated machine learning model and parameters of the digitally simulated optical filter are adapted or trained simultaneously in an integrated optimization process. Moreover, additional constraints such as, for example, the spectrum of the illumination light used for the tissue sample illuminated by the digital capturing system can be taken into consideration.

After the end of the training, the ascertained parameters of the digitally simulated optical filter can then be adopted in a physical filter that exists in reality. Moreover, a digital capturing unit (e.g. an RGB camera) can be used, its number of color channels and type (e.g. in regard to a wavelength sensitivity) being adapted as well as possible to the reduced number of color channels during the training process. In this respect, the constraints of the digital capturing unit—e.g. the RGB camera—available during later productive use could also already be predefined during the training. These measures significantly reduce the required computing power during the prediction phase and help to make the proposed method and the corresponding system usable in real time for supporting surgical interventions. Previously proposed methods fell at this hurdle since integrated optimization was not provided or the required computing power was insufficient for real-time support.

The surgeon can thus be provided with a representation of the tissue to be operated on in a fluorescence representation which allows the surgeon to distinguish between healthy and diseased tissue unambiguously and without further diversion of the surgeon's attention. This holds true even though in productive operation—i.e. during the prediction phase (inference)—it is possible to use just a comparatively simple camera (in contrast to a hyperspectral camera for the training phase).

In this way, a very advantageous optical representation of the tissue to be operated on arises in real time for the surgeon, without time-consuming, multidimensional biopsies being required.

From a technical standpoint, a juxtaposition of differently optimized individual machine learning systems, data transfer between the learning systems, and an additional high expenditure in terms of time and optimization of the individual machine learning systems are obviated as well.

The system presented here is ultimately based very advantageously on an optimization of hardware in the form of the optical filter to be physically produced for the prediction phase, the parameters of which are ascertained during the integrated optimization during the training phase, and the software of the machine learning system used.

Further exemplary embodiments are presented below, which can have validity both in association with the method and in association with the corresponding system.

In accordance with one advantageous embodiment of the method, the trained learning model of the trained machine learning system can comprise providing a plurality of first digital training images of tissue samples which were captured under white light by means of a microsurgical optical system with a second image capturing unit. In this case, a second plurality of color channel information—for example 64 color channels of a hyperspectral camera—for different spectral ranges can be available for each first digital training image.

Moreover, the method can comprise providing a plurality of second digital training images each representing the same tissue samples as the first set of digital training images, wherein the second digital training images can have indications of diseased elements of the tissue samples, and training the machine learning system for forming the trained machine learning model for predicting a digital image of a type of the plurality of second digital training images. In this case, use can be made of the following as input values for the machine learning system: the plurality of first digital training images in the form of the second plurality of color channel information (i.e. e.g. 64 color channels), the plurality of second digital training images as “ground truth”, parameter values for reducing the second plurality of color channel information by means of at least one digitally simulated optical filter for forming the first plurality of color channel information. In this case, a person skilled in the art is aware of the term “ground truth” as the learning goal of the training. This involves the annotated version of training images with the intention of predicting the appearance thereof in the case of unknown inputs for the machine learning system—or generating it as output value/output mapping.

In this case, the plurality of first digital training images can be used as training data for predicting a digital image of the type of the plurality of second digital training images after the second plurality of color channel information has been reduced to the first plurality of color channel information by means of the digitally simulated optical filter. In addition, at least one portion of the parameter values of the at least one optical filter can be output as output values of the machine learning system after the training of the machine learning system has ended. In this context, the portion of the parameter values of the at least one optical filter can also mean that all parameter values ascertained are output.

It should be pointed out that the tissue samples can be for example diseased tissue in the form of cancer tissue, in particular diseased brain tissue. Moreover, it should be noted that the second training images were generated as captured images under visible light and/or under particular lighting conditions—e.g. UV light.

In accordance with a further advantageous embodiment of the method, the parameter values of the at least one optical filter can comprise the plurality of first color channel information and/or a filter shape of the digitally simulated optical filter. In this case, it should be noted that the filter can also consist of a plurality of digitally simulated optical filters. Different parameter values of the optical filter can be varied in this way. During production of optical filters, a plurality of these parameter values can be realized simultaneously.

In accordance with one elegant embodiment of the method, the second plurality of color channel information (i.e. the number of color channels) can be greater than the first plurality of color channel information. By way of example, the second number can constitute the number of color channels of a hyperspectral camera—e.g. 64 color channels (more generally e.g. 30 to 130 color channels)—while the first number constitutes the number of color channels of the first digital image capturing unit. The latter can comprise less than 10—or preferably 3 to 4—color channels. In this way, the number of color channels can be significantly reduced, whereby the required computing power can be distinctly reduced. This has a positive effect on a use of the method directly during an ongoing operation.

In accordance with one extended embodiment of the method, the parameter values for reducing the second number of color channels can relate to a filter shape of the filter or a respective central frequency of the first plurality of color channel information. In accordance with a further embodiment based on this embodiment, the parameter values for reducing the second number of color channels can also relate to one or more camera sensitivity curves (e.g. one per color channel) as envelope or their number and/or shapes of the geometrical described structures; this can relate to a Gaussian distribution, a rectangular shape, etc.

In accordance with one extended embodiment of the method, parameter values for controlling the source of the white light during the capturing of the first digital image can be generated as additional output values of the machine learning system after the training of the machine learning system has ended. By this means, too, the environment variables which were used during the training of the machine learning system with its machine learning model can also be made usable for the actual productive use of the method.

In accordance with one useful embodiment of the method, the digital fluorescence representation can correspond to a representation such as would be generated using a light source in the UV range—e.g. BLUE400. Moreover, spectral ranges can be represented with preference as well. Nevertheless, in the context of this application, the designation “fluorescence representation” should be usable for these other spectral ranges as well. Expediently, for a fluorescence representation—depending on the light used—a contrast agent would be used in the tissue sample: for example 5-ALA (aminolevulinic acid) for an excitation in the wavelength range of 430-440 nm or sodium fluorescein for an excitation in the wavelength range around 560 nm.

In accordance with an additional advantageous embodiment of the method, the learning model can correspond to an encoder-decoder model in terms of its set-up.

Furthermore, embodiments can relate to a computer program product able to be accessed from a computer-usable or computer-readable medium that comprises program code for use by, or in conjunction with, a computer or other instruction processing systems. In the context of this description, a computer-usable or computer-readable medium can be any device that is suitable for storing, communicating, transferring, or transporting the program code.

### OVERVIEW OF THE FIGURES

It is pointed out that exemplary embodiments of the invention may be described with reference to different implementation categories. In particular, some exemplary embodiments are described with reference to a method, whereas other exemplary embodiments may be described in the context of corresponding devices. Regardless of this, it is possible for a person skilled in the art to identify and to combine possible combinations of the features of the method and also possible combinations of features with the corresponding system from the description above and below—if not specified otherwise—even if these belong to different claim categories.

Aspects already described above and additional aspects of the present invention will become apparent inter alia from the exemplary embodiments described and from the additional further specific configurations described with reference to the figures.

Preferred exemplary embodiments of the present invention are described by way of example and with reference to the following figures:

FIG. 1 illustrates a flowchart-like representation of one exemplary embodiment of the computer-implemented method according to the invention for predicting digital fluorescence images.

FIG. 2 shows an extension of the exemplary embodiment in accordance with FIG. 1.

FIG. 3 shows a diagram of one exemplary embodiment for the training phase and the prediction phase for the machine learning system and also a use of the filters.

FIG. 4 shows a diagram of one exemplary embodiment of the number of color channels during the training.

FIG. 5 illustrates two possible wavelength distributions as a result of the joint optimization of the machine learning system and the digitally simulated filter.

FIG. 6 shows the prediction system for predicting digital fluorescence images.

FIG. 7 illustrates one exemplary embodiment of a computer system that comprises the system according to FIG. 6.

### DETAILED DESCRIPTION OF THE FIGURES

In the context of this description, conventions, terms and/or expressions should be understood as follows:

The term “machine learning system” here may describe a system or else a method which is used to generate output values in a non-procedurally programmed manner. For this purpose, in the case of supervised learning, a machine learning model present in the machine learning system is trained with training data and associated desired output values (annotated data or ground truth data). The training phase may be followed by the productive phase, i.e. the prediction phase (“inference phase”), while the output values are generated/predicted from previously unknown input values in a non-procedural manner. A large number of different architectures for machine learning systems are known to the person skilled in the art. They include neural networks, too, which can be trained and used as a classifier, for example. During the training phase, the desired output values given predefined input values are typically learned by means of a method called “backpropagation”, wherein parameter values of nodes of the neural network or connections between the nodes are automatically adapted. In this way the machine learning model inherently present is adjusted or trained in order to form the trained machine learning system with the trained machine learning model.

The term “prediction”, in line with the discussion above, may describe the phase of productive use of a machine learning system. During the prediction phase of the machine learning system, output values are generated or predicted on the basis of the trained machine learning model, to which previously unknown input data are made available.

The term “digital fluorescence image” here describes a digital image of a tissue sample whose form of appearance is that of an image which is observed under light of a specific wavelength (e.g. UV light) with the aid of a contrast agent added to the tissue sample beforehand.

The term “first digital image” here describes a captured recording of a digital image by way of a digital image capturing unit (e.g. RGB camera) with a small number of color channels (e.g. monochromatic or 3 to 4 color channels, generally less than 10 color channels). This first digital image is captured during the prediction phase in order to predict a digital fluorescence image from it. Generally, the terms “number of color channels” and “plurality of color channel information” can be understood as synonyms in the context of this application.

The term “tissue sample” here may describe biological material. It is advantageously available for examinations in this method. This may involve “normal” human tissue or else brain tissue.

The term “microsurgical optical system” here may describe a surgical microscope. The latter can be used for a surgical operation—for example minimally invasive interventions. It can comprise an illumination system, a digital capturing unit (e.g. a digital camera with one or more color channels), an image processing and operator control unit and an output screen.

The term “digital image capturing unit” here may describe a camera with a digital image converter. This camera can capture a plurality of color channel information in parallel. In the case of a hyperspectral camera, for example, 64 color channels can be captured; however, other numbers of color channels are also conceivable (e.g. 30 to 130). Such a camera could be used for capturing training images, while a camera with a significantly more usual number of color channels—e.g. of the order of magnitude of 3 to 4 (or monochromatic)—would be usable for productive use during the prediction phase.

The term “first plurality of color channel information” may describe here the number of color channels of the image capture unit which is used in the prediction mode of operation.

The term “optical filter” here may be a device which allows incident optical beams to pass through selectively according to specific criteria. The criteria may be wavelength-selective (or dependent on the polarization state), such that the filter is more transmissive for specific different wavelength ranges and less transmissive (down to practically not transmissive at all) for others.

The term “second digital image” may describe the predicted image which is generated by the machine learning system during productive operation.

The term “digital fluorescence representation” here may be a specific representation of a digital image which appears as if it had been illuminated with light of a specific wavelength (e.g. UV light), whereby fluorescence effects in regard to a contrast agent present in a biological tissue, for example, would become visible as a result of the light of the specific wavelength.

The term “white light” describes light from a light source (e.g. white light LED, xenon, etc.) which primarily emits in the visible wavelength spectrum.

The term “parameter values of the at least one optical filter” describes substantially wavelengths—or the ranges thereof—in which the filter is transmissive. The envelope in a transmission-versus-wavelength representation can be—exactly like a mean value of the transmission range—a further parameter.

The term “first digital training image” here describes a digital image for which a high number of color channels (e.g. 64 or more generally: 30 to 130 color channels) are available.

The term “second image capturing unit” describes an image capturing unit which is adapted to provide a high number of color channel data for a recording, as is the case for a hyperspectral camera, for example.

The term “second digital training image” describes a digital image of the ground truth data which are indispensable for training a machine learning system in the case of supervised learning. The ground truth data represent the type of digital images which are expected as prediction, i.e. which are intended to be “learned”.

The term “indications of diseased elements of the tissue samples” may be identified by different annotations in a digital image. This may involve pixelwise annotation of a specific image excerpt, a region marked in color in some other way, or a specific form of the segmentation of the digital image.

The term “parameter values for reducing the second plurality of color channel information” may describe characteristics of the digitally simulated filter. This may concern the number or else the transmission characteristic of the filter.

The term “digitally simulated optical filter” denotes a unit of the machine learning system which alters the color channel information. This may involve digital color transmission filters.

The term “filter shape of the digitally simulated optical filter” may denote for example the envelope of the transmissive spectral lines (or wavelength range) for the filter, the mean values thereof or an associated standard deviation.

The term “parameter values for controlling the source of the white light” may describe characteristics of the white light used which are used for creating the digital images. This may essentially involve spectral range and intensity values of the emitted light of the illumination source.

The term “encoder-decoder model” here describes an architecture of a machine learning system in which input data are encoded or coded in order then to be decoded again immediately afterwards. In the middle between the encoder and the decoder the necessary data are present as a type of feature vector. During decoding, depending on the training of the machine learning model, specific features in the input data can then be specially highlighted.

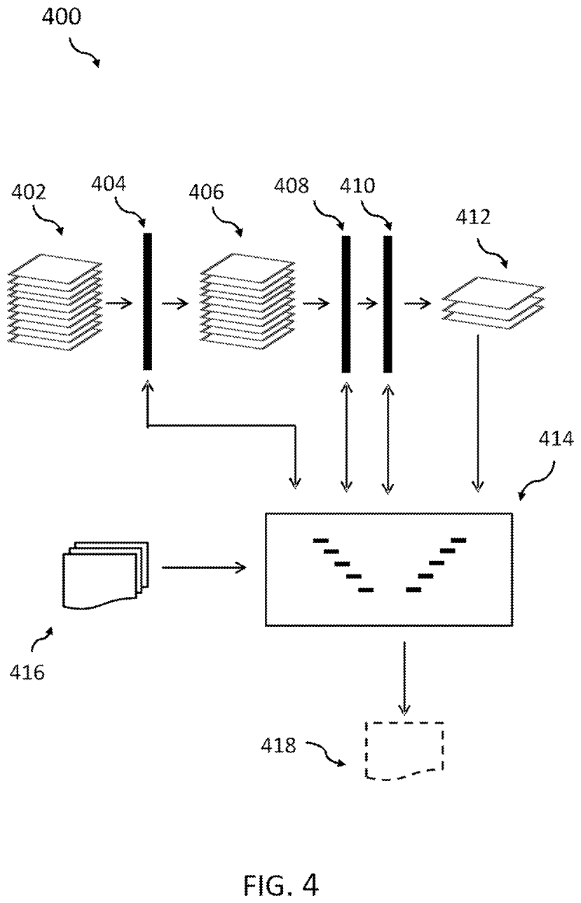

The term “U-Net architecture” here describes an architecture of a machine learning model which has internally a contracting path and an expanding path. A more detailed definition is given in association with FIG. 4.

A detailed description of the figures is given below. It is understood in this case that all of the details and instructions in the figures are illustrated schematically. Firstly, a flowchart-like representation of one exemplary embodiment of the computer-implemented method according to the invention for predicting digital fluorescence images is presented. Further exemplary embodiments, or exemplary embodiments for the corresponding system, are described below:

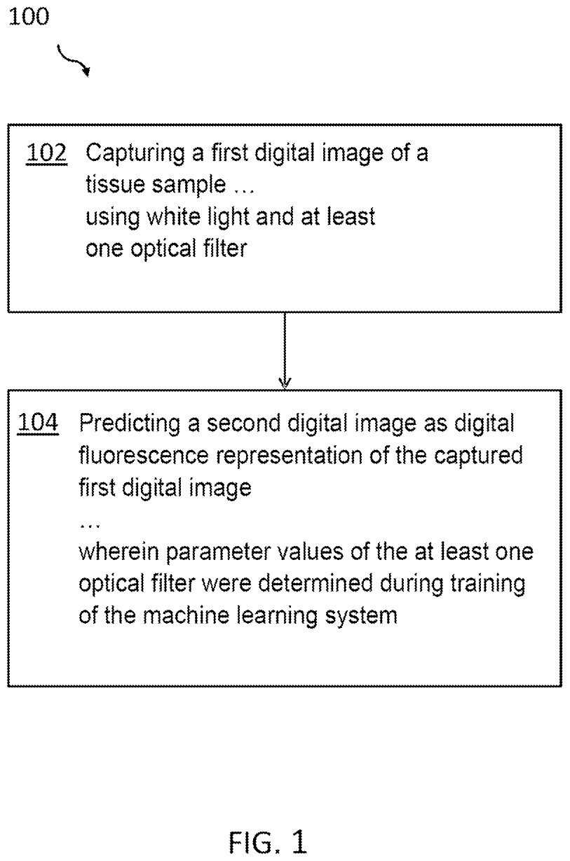

FIG. 1 illustrates a flowchart-like representation of one preferred exemplary embodiment of the computer-implemented method 100 for predicting digital fluorescence images. In this case, the method comprises capturing 102 a first digital image of a tissue sample—e.g. diseased brain tissue—by means of a microsurgical optical system with a first digital image capturing unit, e.g. an RGB camera—with a first plurality of color channel information—e.g. with 3 to 4 color channels—using white light and at least one optical filter. The filter is typically situated between the illuminated tissue sample and the camera.

Furthermore, the method 100 comprises predicting 104 a second digital image in the form of a digital fluorescence representation of the captured first digital image by means of a trained machine learning system comprising a trained learning model for predicting a corresponding digital fluorescence representation of an input image.

As input data or input image, use is made of the first captured digital image for the trained machine learning system; moreover, parameter values of the at least one optical filter were determined during training of the machine learning system.

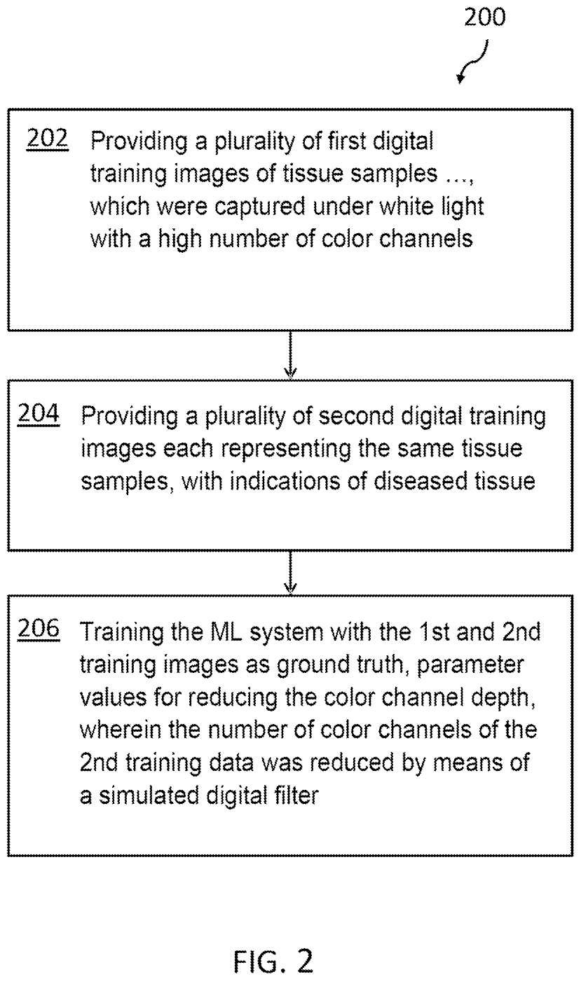

FIG. 2 shows an extension of the exemplary embodiment in accordance with FIG. 1, in particular the training phase 200 of the above-described method illustrated during its productive or prediction phase in FIG. 1. In this case, training the combined machine learning model of the trained combined machine learning system comprises providing 202 a plurality of first digital training images of tissue samples—i.e. for example once again brain tissue or cancer tissue—which were captured under white light by means of a microsurgical optical system—i.e. e.g. a surgical microscope—with a second image capturing unit, wherein a second plurality of color channel information for different spectral ranges are available for each first digital training image. This second number is typically greater than the first number of color channels in the productive prediction mode of operation in accordance with FIG. 1. A hyperspectral camera with e.g. 64 color channels would advantageously be used.

Moreover, the training phase 200 comprises providing 204 a plurality of second digital training images each representing the same tissue samples as the first set of digital training images. In this case, the second digital training images contain indications of diseased elements of the tissue samples. These indications can assume various forms, such as e.g. pixelwise annotations, optically highlighted encircled areas and/or boundaries of diseased tissue regions or other image segmentations. The representation can be that under normal visible, e.g. white, light or under special light and highlighting by a contrast agent (fluorescence representation).

Furthermore, the training phase 200 comprises the actual training 206 of the machine learning system—under so-called supervised learning—for forming the trained machine learning model for predicting a digital image of a type of the plurality of second digital training images, i.e. with visible markings of diseased tissue. In this case, the following are used as input values for the combined machine learning system: (i) the plurality of first digital training images in the form of the second plurality of color channel information—i.e. with the higher plurality of color channel information—(ii) the plurality of second digital training images as ground truth—i.e. the desired result images to be trained—and (iii) parameter values for reducing the second plurality of color channel information by means of at least one digitally simulated optical filter for forming the first plurality of color channel information. In this case, the parameter values can comprise the number of filters, indications concerning color spectra or filter shapes.

Moreover, the plurality of first digital training images are used as training data for predicting a digital image of the type of the plurality of second digital training images after the second plurality of color channel information has been reduced to the first plurality of color channel information by means of the digitally simulated optical filter. This is done in one go, without different systems or different machine learning systems being used.

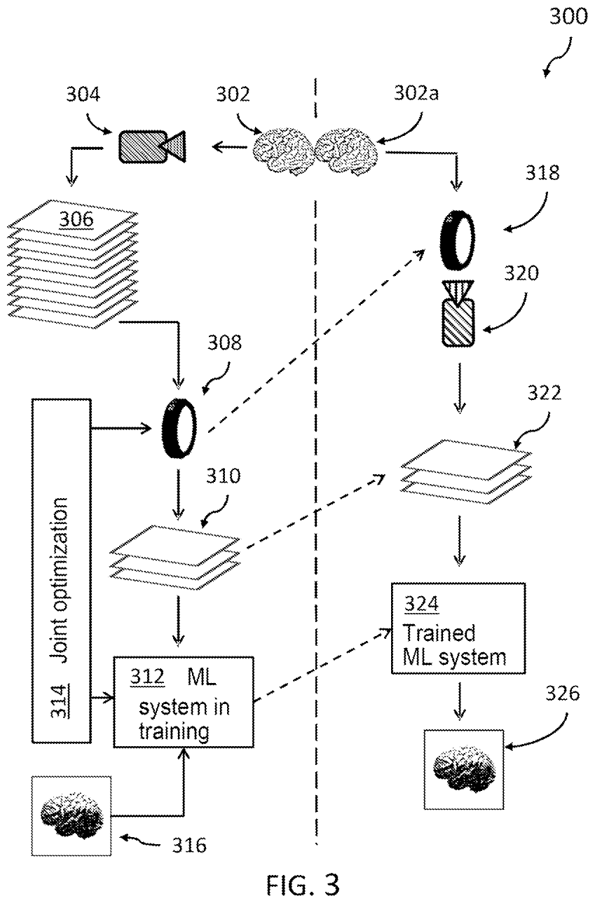

In addition, parameter values of the at least one optical filter are output as output values of the machine learning system after the training of the machine learning system has ended. That is to say that the learning system thus learns as it were the properties of the simulated optical filter during the training of the machine learning system for forming the machine learning model. The parameter values of the at least one optical filter can concern e.g. a number of filters or associated frequency bands. The properties of the digitally simulated filter can then be used directly in order to produce an optical filter of this type in order to use it in the prediction phase, as described in even greater detail in FIG. 3.

FIG. 3 shows a simultaneous representation 300 of the training phase and the prediction phase for the machine learning system and also a use of the filters. The left-hand side of the figure relates to the training phase, while the right-hand side of the figure relates to the prediction phase. A plurality of tissue samples 302 are captured by a digital capturing system 304 with a high number of color channels 306 for generating training data from the tissue 302. These digital images (first training data) are guided through a digitally simulated filter 308, such that these digital images 310 downstream of the digitally simulated filter 308 are available in a representation with a reduced number of color channels 310.

These digital images 310 thus reduced in terms of the number of color channels are then used as training data for the machine learning system 312. As annotated data for the training, marked versions of digital images of the first training data are fed as second training data to the machine learning system 312.

In addition, the properties of the optical filter(s) 308 are varied, thereby influencing the learning speed and the learning success (fast or slow convergence) of the machine learning system 312. This results in a joint optimization 314 of the digitally simulated optical filter(s) 308 and of the parameters of the machine learning system 312, such that a machine learning model which can be used productively in the prediction phase (right-hand side of FIG. 3) is available at the end of the training phase.

The phase of use of the trained machine learning system 324, which is depicted by way of example on the right-hand side of FIG. 3, also begins with capturing a biological tissue 302a. This can be done for example during an operation or an examination by means of an image capturing unit 320—i.e. e.g. an RGB camera. The potentially diseased tissue 302a is for example illuminated with white light (illumination source not illustrated) and converted into a digital image by the capturing unit/camera 320 after filtering of the beams by the optical filter(s) 318. This digital image consists of the pieces of color information from, for example, 3-4 color channels 322. Ideally, the number of color channels 322 corresponds to that of the color channels 312 which were generated from the color channels 306 of the hyperspectral camera 304 by the digitally simulated optical filter 310 during the training of the machine learning system 312. The respectively equivalent elements of the training phase and the prediction phase are indicated by dashed arrows from the left-hand side of FIG. 3 to the right-hand side of FIG. 3.

The digital image captured by the camera 320 (for example an RGB camera) with the smaller number of color channels 322 is fed to the trained machine learning system 324—i.e. used as input data—in order to output a digital output image 326 in the form of a fluorescence representation.

In this context, it should be explicitly pointed out once again that the filter 308 during the training of the machine learning system 312 is digitally simulated, while the filter 318 used during the prediction phase of the trained machine learning system 324 is a filter which exists in reality and which has the optical characteristics or parameters which the trained machine learning system 314 actually outputs at the end of the training. Consequently, the real optical filter 318 is produced exactly according to the specifications which were ascertained during the joint optimization 314 of the digitally simulated filter 308 and of the parameters of the machine learning system 312 in the training. Ground truth data 316 are also required as additional input values for the training.

FIG. 4 illustrates a diagram of an exemplary embodiment 400 regarding the number of color channels during the training. The N color channels 402, which for example are the result of a digital recording (of a digital image) of a hyperspectral camera, can be neutralized (i.e. made independent) regarding the properties 404 of the light source, such that these properties can also be used as additional constraints during the training of the machine learning system 414. Examples of such constraints may be the number thereof as well as the availability of the light at different wavelengths, its density and respective intensity.

The pieces of color information which are then available by virtue of the same number of color channels 406 for a captured image are then abstracted from the properties of the light source used. Next, the constraints of the simulated optical filter 408 which are optimized together with the properties of the machine learning system 414 (cf. correspondingly the machine learning system 312, 324 in FIG. 3) can be taken into consideration. Furthermore, camera sensitivity parameters (in particular with regard to specific wavelengths) can also be taken into consideration as additional constraints 410. As a result, this gives rise to a digital image with a reduced number 412 of color channels, which is smaller (or significantly smaller) than the number of color channels 402 of the digital input image.

The double-headed arrows between the symbolically represented constraints 404, 408, 410 symbolize the influence on the machine learning system 414 during the training. As input data, the digital training image(s) with the reduced number 412 of color channels is/are fed to the machine learning system. For the purposes of supervised learning, reference data (ground truth data) 416 representing the respectively expected result for a digital training image are also fed to the machine learning system 414 during the training. These ground truth data 416 ultimately represent the expected output image in a fluorescence representation, which image is intended to be (predicted) is expected when a digital input image with the high number of color channels 402 is present.

Moreover, further parameters 418 can be output. These primarily concern the characteristics of the digitally simulated optical filter 408 and also for example spectral range properties of the illumination source for the prediction phase or else spectral range sensitivity parameters of the digital capturing unit to be used in the prediction phase (i.e. the RGB camera, a monochromatic camera, or the like).

By way of example, a U-Net can be used as machine learning system 414. This consists, as is known, of a contracting path and an expanding path, as is indicated by the symbol 414. It can consist for example of a repeated application of two 3×3 convolutions (unpadded convolutions), preceded in each case by an amplifying linear unit (ReLU) and a 2×2 pooling operation with stride 2 for downsampling. In this case, the number of feature channels is doubled with each downsampling step. On the other side, the expanding path consists of an upsampling of the feature map followed by a 2×2 convolution (“up-sampling”), which halves the number of feature channels in each case, and a concatenation of the feature maps correspondingly “cropped” by the contracting path, and two 3×3 convolutions, each followed by an ReLU.

For the case where underrepresented fluorescence groups would be present, data augmentation techniques (L/R mirror images, top/bottom mirror images, random rotation, random image crops, etc.) can be applied in order to use the number of training images in all possible groups with as far as possible the same intensity. Alternatively, images of anatomical variants could also be used.

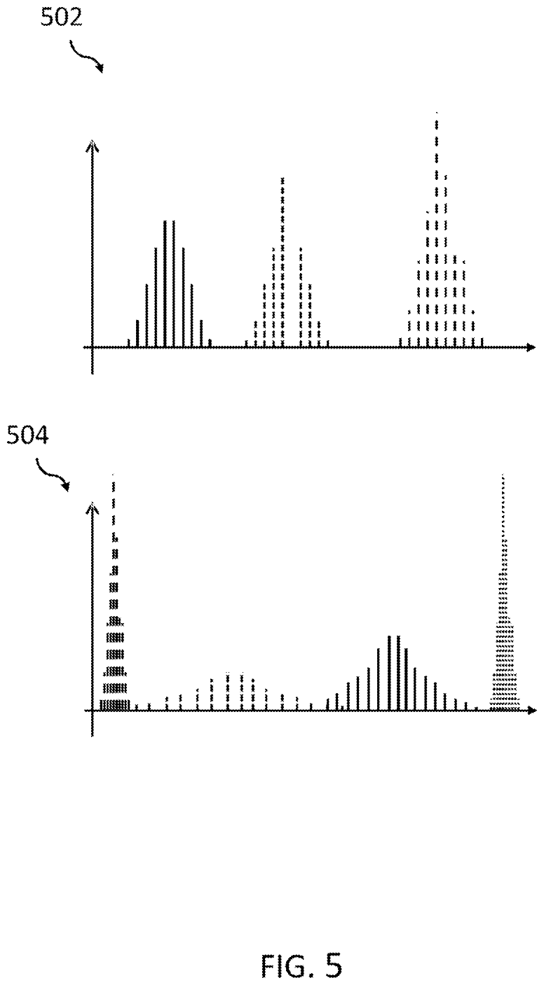

FIG. 5 illustrates two possible wavelength distributions (or frequency distributions) as a result of the joint optimization of the machine learning system (cf. FIG. 3, 312) and the digitally simulated filter. The diagram 502 indicates essentially three mutually separate frequency/wavelength ranges that can easily be converted into an RGB representation. The diagram 504 has four filter ranges with varying damping for different frequency ranges. It should be pointed out that this actually only involves two possible examples in which each spectral range can represent a sensor channel of the digital capturing unit. The height of the vertical lines corresponds to weighted sensitivities of the respective filter at the respective wavelength. In this case, an additional constraint of the representation 502 concerns the fact that the three channels each have a Gaussian sensitivity distribution with a relatively small standard deviation. The representation 504 has four maxima, of which for example one may be in the blue range, one in the green range and two in the red range. Here, too, the standard deviation is comparatively small. If no optimization were provided during the learning phase of the machine learning system, the intensity lines of potential filters would be distributed over the x-axis mathematically more chaotically as it were (not illustrated); no separate spectral ranges that could be converted into a real, physical optical filter would be discernible.

Ideally, the real optical filter (cf. 318, FIG. 3) has exactly the same sensitivity curves.

These three possible physical constraints presented for the filters represent good examples here. In this case, the representation 502 represents a completely described sensitivity specification (i.e. no variation of the filter parameters is performed during the training). In this case, the representation 504 would correspond to the characteristics (or parameters) of the sensitivity curves of a camera to be used later (during the prediction phase); in other words, Gaussian sensitivity state curves with constraints such as, for example, small standard deviation and a specific value for the highest sensitivity value of a predefined wavelength, etc. The last case described in the paragraph before last would probably be able to be realized only with difficulty in a 1:1 manner in terms of hardware with regard to an actual physical filter.

In the same way, in further embodiments, properties of the light source used could be used as additional constraints during the training phase.

Further embodiments can provide a temporal sequence of digitally captured images. The aim here would be to avoid greatly varying digital specking if successive images are used (“flicker”). A simple countermeasure that could be provided is post-processing of the individual captured frames (individual images) by way of softer transitions over time. In a further-developed form, in a further embodiment, the generation of a 3D model could be provided, such that all 2D operations of the 2D model are performed in three-dimensional space (i.e. 3D convolutions, 3D pooling, etc.). A combination of a 2D model with time-limited models can also be used as an additional further-developed exemplary embodiment.

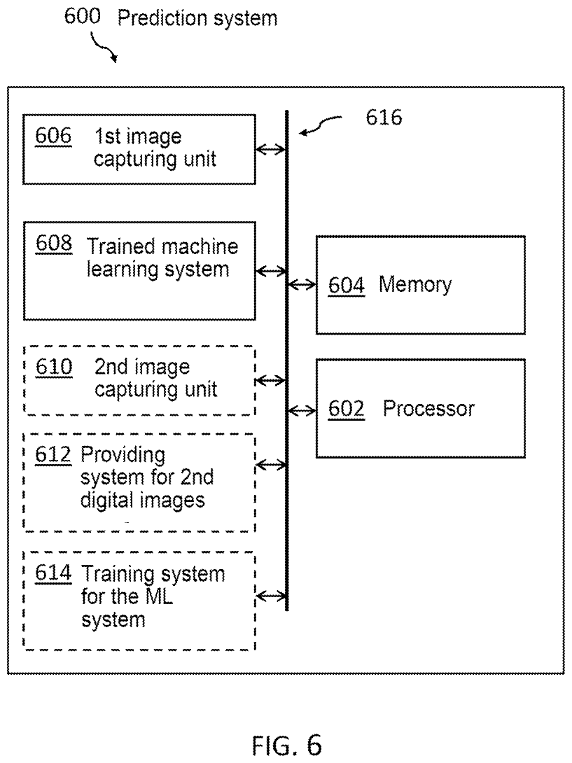

FIG. 6 shows one exemplary embodiment of the prediction system 600 for predicting digital fluorescence images. In this case, the prediction system comprises a memory 604 that stores a program code and one or more processors 602 that are connected to the memory and, when they execute the program code, cause the prediction system 600 to control the following units: a first digital image capturing unit 606 with a first plurality of color channel information for capturing a first digital image of a tissue sample by means of a microsurgical optical system using white light and at least one optical filter, and a trained machine learning system 608 for predicting a second digital image in the form of a digital fluorescence representation of the captured first digital image. In this case, the trained machine learning system comprises a trained learning model for predicting a corresponding digital fluorescence representation of an input image; the first captured digital image is used as input image for the trained machine learning system; and parameter values of the at least one optical filter were determined during training of the machine learning system.

Furthermore, the prediction system 600 can either explicitly comprise a second image capturing unit 610 for capturing the plurality of first digital training images of tissue samples, which were captured under white light by means of a microsurgical optical system, or fulfill the function of that unit by way of the interactions of the program code stored in the memory 604 with the processor 602. In this case, a second plurality of color channel information for different spectral ranges are available for each first digital training image.

Furthermore, there can be present a providing unit 612 for providing a plurality of second digital training images, which in each case represent the same tissue samples as the first set of digital training images, wherein the second digital training images have indications of diseased elements of the tissue samples. The providing unit 612 can be implemented as an image memory.

Moreover, provision can furthermore be made of a training system 614 for training the machine learning system for forming the trained machine learning model for predicting a digital image of a type of the plurality of second digital training images. In this case, use is made of the following as input values for the machine learning system: the plurality of first digital training images in the form of the second plurality of color channel information, the plurality of second digital training images as ground truth (or ground truth data), and parameter values for reducing the second plurality of color channel information by means of at least one digitally simulated optical filter for forming the first plurality of color channel information, wherein the plurality of first digital training images are used as training data for predicting a digital image of the type of the plurality of second digital training images after the second plurality of color channel information has been reduced to the first plurality of color channel information by means of the digitally simulated optical filter. Parameter values of the at least one optical filter are additionally output as output values of the machine learning system after the training of the machine learning system has ended.

Express reference is made to the fact that the modules and/or units—in particular the processor 602, the memory 604, the first digital image capturing unit 606, the trained machine learning system 608, the second image capturing unit 610, the providing unit 612 and the training system 614—can be connected to electrical signal lines or via a system-internal bus system 616 for the purpose of exchanging signals and/or data and for the purpose of cooperative behavior.

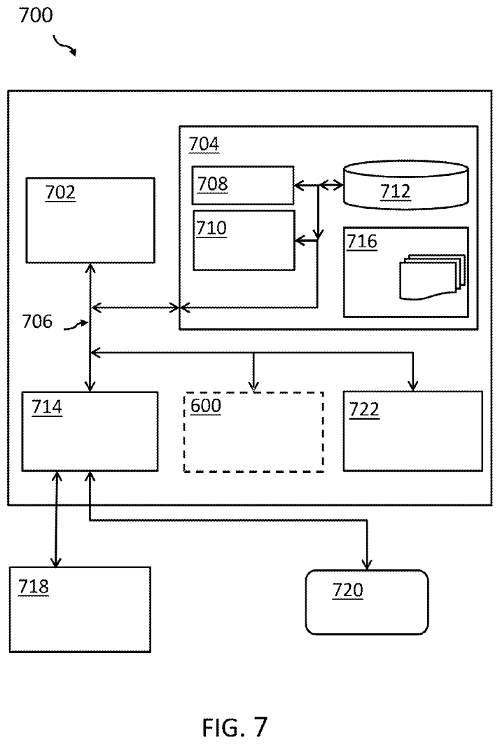

FIG. 7 illustrates a diagram of a computer system 700 that may comprise at least parts of the prediction system. Embodiments of the concept proposed here may in principle be used with practically any type of computer, regardless of the platform used therein to store and/or execute program codes. FIG. 6 illustrates by way of example a computer system 700 that is suitable for executing program code according to the method presented here. A computer system already present in a surgical microscope may also serve as a computer system for implementing the concept presented here, possibly with corresponding expansions.

The computer system 700 has a plurality of general-purpose functions. The computer system can in this case be a tablet computer, a laptop/notebook computer, another portable or mobile electronic device, a microprocessor system, a microprocessor-based system, a computer system with specifically configured special functions or else a constituent part of a computer-controlled microscope system. The computer system 700 can be configured for executing computer system-executable instructions—such as for example program modules—that can be executed in order to implement functions of the concepts proposed here. For this purpose, the program modules can comprise routines, programs, objects, components, logic, data structures etc. in order to implement particular tasks or particular abstract data types.

The components of the computer system may comprise the following: one or more processors or processing units 702, a storage system 704 and a bus system 706 that connects various system components, including the storage system 704, to the processor 702. The computer system 700 typically comprises a plurality of accessible volatile or nonvolatile storage media to which the computer system 700 has access. The storage system 704 can store the data and/or instructions (commands) of the storage media in volatile form—such as for example in a RAM (random access memory) 708—in order to be executed by the processor 702. These data and instructions realize one or more functions and/or steps of the concept presented here. Further components of the storage system 704 can be a permanent memory (ROM) 710 and a long-term memory 712 in which the program modules and data (reference sign 716) and also workflows can be stored.

The computer system comprises a number of dedicated devices (keyboard 718, mouse pointing device (not illustrated), screen 720, etc.) for communication purposes. These dedicated devices can also be combined in a touch-sensitive display. An I/O controller 714, provided separately, ensures a smooth exchange of data with external devices. A network adapter 722 is available for communication via a local or global network (LAN, WAN, for example via the Internet). The network adapter can be accessed by other components of the computer system 700 via the bus system 706. It is understood in this case—although it is not illustrated—that other devices can also be connected to the computer system 700.

In addition, at least parts of the prediction system 600 for predicting digital fluorescence images (cf. FIG. 6) can be connected to the bus system 706. The prediction system 600 and the computer system 700 may optionally use a memory and/or the processor jointly.

The description of the various exemplary embodiments of the present invention has been given for the purpose of improved understanding, but does not serve to directly restrict the inventive concept to these exemplary embodiments. A person skilled in the art will themselves develop further modifications and variations. The terminology used here has been selected so as to best describe the basic principles of the exemplary embodiments and to make them easily accessible to a person skilled in the art.

The principle presented here can be embodied both as a system, as a method, combinations thereof and/or as a computer program product. The computer program product can in this case comprise one (or more) computer-readable storage medium/media comprising computer-readable program instructions in order to cause a processor or a control system to implement various aspects of the present invention.

As media, electronic, magnetic, optical, electromagnetic or infrared media or semiconductor systems are used as forwarding medium; for example SSDs (solid state devices/drives as solid state memory), RAM (random access memory) and/or ROM (read-only memory), EEPROM (electrically erasable ROM) or any combination thereof. Suitable forwarding media also include propagating electromagnetic waves, electromagnetic waves in waveguides or other transmission media (for example light pulses in optical cables) or electrical signals transmitted in wires.

The computer-readable storage medium can be an embodying device that retains or stores instructions for use by an instruction execution device. The computer-readable program instructions that are described here can also be downloaded onto a corresponding computer system, for example as a (smartphone) app from a service provider via a cable-based connection or a mobile radio network.

The computer-readable program instructions for executing operations of the invention described here can be machine-dependent or machine-independent instructions, microcode, firmware, status-defining data or any source code or object code that is written for example in C++, Java or the like or in conventional procedural programming languages such as for example the programming language “C” or similar programming languages. The computer-readable program instructions can be executed in full by a computer system. In some exemplary embodiments, there can also be electronic circuits, such as, for example, programmable logic circuits, field-programmable gate arrays (FPGAs) or programmable logic arrays (PLAs), which execute the computer-readable program instructions by using status information of the computer-readable program instructions in order to configure or to individualize the electronic circuits according to aspects of the present invention.

The invention presented here is furthermore illustrated with reference to flowcharts and/or block diagrams of methods, apparatuses (systems) and computer program products according to exemplary embodiments of the invention. It should be pointed out that practically any block of the flowcharts and/or block diagrams can be embodied as computer-readable program instructions.

The computer-readable program instructions can be made available to a general-purpose computer, a special computer or a data processing system able to be programmed in another way in order to create a machine such that the instructions that are executed by the processor or the computer or other programmable data processing devices generate means for implementing the functions or procedures that are illustrated in the flowchart and/or block diagrams. These computer-readable program instructions can correspondingly also be stored on a computer-readable storage medium.

In this sense, any block in the illustrated flowchart or the block diagrams can represent a module, a segment or portions of instructions that represent a plurality of executable instructions for implementing the specific logic function. In some exemplary embodiments, the functions represented in the individual blocks can be implemented in a different order—optionally also in parallel.

The illustrated structures, materials, sequences, and equivalents of all of the means and/or steps with associated functions in the claims below are intended to apply all of the structures, materials or sequences as expressed by the claims.

### REFERENCE SIGNS

100 Method
102 Step of the method 100
104 Step of the method 100
200 Extended method 100
202 Step of the method 200
204 Step of the method 200
206 Step of the method 200
300 Comparison of training phase vs. prediction phase
302 Tissue
304 Hyperspectral camera, capturing system
306 Color channels
310 Reduced number of color channels
312 Machine learning system in training
314 Joint optimization
316 Ground truth data
318 Physical filter
320 Image capturing unit, camera
322 Color channels
324 Learning system
326 Output image
400 Exemplary embodiment
402 Color channels
404 Constraints, properties
406 Color channels
408 Filter, constraint
410 Filter, constraints
412 Reduced number of color channels
414 Learning system
416 Ground truth data
418 Further output parameters
502 Three mutually separate frequency/wavelength ranges
504 Representation with four wavelength maxima
600 Prediction system
602 Processor
604 Memory
606 Image capturing unit
608 Learning system
610 Image capturing unit
612 Providing unit
614 Training system
616 Bus system
700 Computer system
702 Processor
704 Storage system
706 Bus system
708 RAM
710 ROM
712 Long-term memory
714 I/O controller
716 Program modules and data
718 Keyboard
720 Screen
722 Network adapter

1. A computer-implemented method for predicting digital fluorescence images, the method comprising
capturing a first digital image of a tissue sample by means of a microsurgical optical system with a first digital image capturing unit with a first plurality of color channel information using white light and at least one optical filter,
predicting a second digital image in the form of a digital fluorescence representation of the captured first digital image by means of a trained machine learning system comprising a trained learning model for predicting a corresponding digital fluorescence representation of an input image,
wherein the first captured digital image is used as input image for the trained machine learning system, and
wherein parameter values of the at least one optical filter were determined during training of the machine learning system.

2. The method according to claim 1, wherein training the learning model of the trained machine learning system comprises:
providing a plurality of first digital training images of tissue samples, which were captured under white light by means of a microsurgical optical system with a second image capturing unit, wherein a second plurality of color channel information for different spectral ranges are available for each first digital training image,
providing a plurality of second digital training images each representing the same tissue samples as the first set of digital training images, wherein the second digital training images have indications of diseased elements of the tissue samples,
training the machine learning system for forming the trained machine learning model for predicting a digital image of a type of the plurality of second digital training images, wherein use is made of the following as input values for the machine learning system:
the plurality of first digital training images in the form of the second plurality of color channel information,
the plurality of second digital training images as ground truth,
parameter values for reducing the second plurality of color channel information by means of at least one digitally simulated optical filter for forming the first plurality of color channel information,
wherein the plurality of first digital training images are used as training data for predicting a digital image of the type of the plurality of second digital training images after the second plurality of color channel information has been reduced to the first plurality of color channel information by means of the digitally simulated optical filter, and
wherein at least one portion of the parameter values of the at least one optical filter are output as output values of the machine learning system after the training of the machine learning system has ended.

3. The method according to claim 1, wherein the parameter values of the at least one optical filter comprise: the plurality of first color channel information and/or a filter shape of the digitally simulated optical filter.

4. The method according to claim 1, wherein the second plurality of color channel information is greater than the first plurality of color channel information.

5. The method according to claim 1, wherein the parameter values for reducing the second number of color channels are at least one selected from the group consisting of a filter shape and a respective central frequency of the first plurality of color channel information.

6. The method according to claim 2, wherein parameter values for controlling the source of the white light during the capturing of the first digital image are generated as additional output values of the machine learning system after the training of the machine learning system has ended.

7. The method according to claim 1, wherein the digital fluorescence representation corresponds to a representation such as would be generated using a light source in the UV range.

8. The method according to claim 1, wherein the learning model corresponds to an encoder-decoder model in terms of its set-up.

9. The method according to claim 1, wherein the encoder-decoder model is a convolutional network in the form of a U-Net architecture.

10. A prediction system for predicting digital fluorescence images, wherein the prediction system comprises the following:
a memory that stores a program code and one or more processors that are connected to the memory and, when they execute the program code, cause the prediction system to control the following units:
a first digital image capturing unit with a first plurality of color channel information for capturing a first digital image of a tissue sample by means of a microsurgical optical system using white light and at least one optical filter,
a trained machine learning system for predicting a second digital image in the form of a digital fluorescence representation of the captured first digital image, wherein the trained machine learning system comprises a trained learning model for predicting a corresponding digital fluorescence representation of an input image,
wherein the first captured digital image is used as input image for the trained machine learning system, and
wherein parameter values of the at least one optical filter were determined during training of the machine learning system.

11. A computer program product for predicting digital fluorescence images, the computer program product comprising a computer-readable storage medium comprising program instructions stored thereon, the program instructions being executable by one or more computers or control units, and causing said one or more computers or control units to carry out the method according to claim 1.
